(19) United States
(12) Patent Application Publication
(10) Pub. No.: US 2026/0254321 A1
(43) Pub. Date: Aug. 27, 2026

(54) ROTATING ELECTRICAL MACHINE AND METHOD OF MANUFACTURING ROTATING ELECTRICAL MACHINE

(71) Applicant: HONDA MOTOR CO., LTD., Tokyo (JP)

(72) Inventors: Yoshiyuki IZUMI, Tokyo (JP); Takuro YOSHIMURA, Tokyo (JP); Dai SASAKI, Tokyo (JP); Hiroshi NAKAJIMA, Tokyo (JP)

(21) Appl. No.: 19/450,753

(22) Filed: Jan. 16, 2026

(30) Foreign Application Priority Data
Feb. 25, 2025 (JP) 2025-028345

(51) Int. Cl. H02K 9/19; H02K 1/16; H02K 3/12; H02K 3/32; H02K 15/108

(52) U.S. Cl. CPC H02K 9/19; H02K 1/16; H02K 3/12; H02K 3/32; H02K 15/108

(57) ABSTRACT

The rotating electrical machine includes: a stator in which coils are accommodated in a plurality of slots with insulating paper interposed therebetween, respectively; and a rotor that is accommodated in the axial hole of the stator and includes therein a flow path for a refrigerant, the stator having coil ends, the rotor having an outflow port for the refrigerant, the refrigerant that has flowed out from the outflow port being scattered toward the coil ends by rotation of the rotor. The insulating paper includes a foam layer that has foamed by being heated in the slots and fills a clearance between the slots and the coils, and is accommodated in the slots such that ends of the insulating paper protrude from the slots, and the ends of the insulating paper are provided with volume reduction treatment portions having higher mechanical strength than foamed portions in the slots.

### CROSS-REFERENCE TO RELATED APPLICATION

This application is based on and claims the benefit of priority from Japanese Patent Application No. 2025-028345, filed on 25 February 2025, the content of which is incorporated herein by reference.

### BACKGROUND OF THE INVENTION

### Field of the Invention

The present disclosure relates to a rotating electrical machine and a method of manufacturing the rotating electrical machine.

### Related Art

A rotating electrical machine includes a stator and a rotor. The stator is configured by mounting coils in a plurality of slots of a stator core, respectively. The rotor is rotatably supported in an axial hole of the stator. The coils are inserted into the slots with insulating paper interposed, and portions of the coils that protrude from end surfaces in an axial direction of the stator form coil ends. Insulating paper including a foam layer is known. The foam layer is heated and foamed in the slot to fill a clearance between the slot and the coil to thereby hold the coil. Both ends of the insulating paper inserted into the slot slightly protrude from an opening of the slot in the axial direction of the stator to prevent contact between the coil and an opening edge of the slot and ensure a creeping distance (for example, see Patent Document 1).

In addition, a rotor is known to perform a cooling function by causing a refrigerant to flow through a flow path formed inside the rotor. The rotor having the cooling function has an outflow port, through which the refrigerant flows out, on an end surface in an axial direction of the rotor (for example, see Japanese Patent No. 6594401).

Patent Document 1: PCT International Publication No. WO2020/067352

Patent Document 2: Japanese Patent No. 6594401

### SUMMARY OF THE INVENTION

When the rotor having the cooling function rotates, the refrigerant that has flowed out from the outflow port is scattered by a centrifugal force toward coil ends of the stator disposed outward in a radial direction. Thus, the coil ends are also cooled by the refrigerant. However, there is a problem in that the scattered refrigerant collides with an end of insulating paper protruding from a slot to damage a foam layer of the insulating paper. This is because resin walls separating foam beads (resin particles) in a substrate resin become thinner in the foam layer after foaming due to expansion of the foam beads. When a scattering pressure caused when the refrigerant from the rotor collides at high speed with the insulating paper exceeds material strength of the resin wall, the resin wall is scraped and peeled off due to a direct impact of the refrigerant, resulting in undesirable contamination.

To prevent damage to the foam layer, it is also conceivable to change a design of the stator or the rotor to a structure in which the refrigerant scattered from the rotor does not collide with the end of the insulating paper, or bend the end of the insulating paper protruding from the slot such that the foam layer is disposed on an inner side, thereby preventing the scattered refrigerant from directly colliding with the foam layer. However, these approaches incur excessive costs for each model of rotating electrical machine, and new equipment needs to be introduced to bend the insulating paper. As such, neither of these approaches can be considered economical.

In view of the foregoing, an object of the present disclosure is to provide a rotating electrical machine and a method of manufacturing the rotating electrical machine that can easily prevent contamination caused by damage to a foam layer of insulating paper due to a refrigerant scattered from a rotor.

(1) A first aspect of the present disclosure relates to a rotating electrical machine (e.g., a rotating electrical machine 1 to be described below) including: a stator (e.g., a stator 2 to be described below) in which coils (e.g., coils 5 to be described below) are accommodated in a plurality of slots (e.g., slots 23 to be described below) arranged around an axial hole (e.g., an axial hole 22 to be described below) with insulating paper (e.g., insulating paper 4 to be described below) interposed therebetween, respectively; and a rotor (e.g., a rotor 3 to be described below) that is rotatably accommodated in the axial hole of the stator and includes therein a flow path (e.g., a refrigerant flow path 314 to be described below) for a refrigerant. The stator has coil ends (e.g., coil ends 50 to be described below) that are formed by the coils protruding from the slots in an axial direction of the stator. The rotor has an outflow port (e.g., an outflow port 314a) for the refrigerant. The refrigerant that has flowed out from the outflow port is scattered toward the coil ends of the stator by rotation of the rotor. The insulating paper includes a foam layer (e.g., a foam layer 42 to be described below) that has foamed by being heated in the slots and fills a clearance between the slots and the coils, and being accommodated in the slots such that ends (e.g., protrusion ends 4d to be described below) of the insulating paper protrude from the slots in the axial direction of the stator, and the ends of the insulating paper are provided with volume reduction treatment portions (e.g., volume reduction treatment portions Fb to be described below) having higher mechanical strength than foamed portions in the slots, in which the foam layer is reduced in volume due to breakage of foamed bubbles.

According to (1) above, it is possible to improve the strength of the foam layer at the end by simply forming the volume reduction treatment portion in the foam layer corresponding to the end of the insulating paper. Therefore, it is possible to easily prevent the contamination caused by damage to the foam layer of the insulating paper due to collision with the refrigerant scattered from the rotor. Since there is no need to change the design of the stator and the rotor or to introduce new equipment, there is no increase in costs, and it is possible to economically cope with the problem of damage to the foam layer of the insulating paper due to the refrigerant scattered from the rotor at low cost.

(2) According to a second aspect, in the rotating electrical machine described in (1) above, the volume reduction treatment portions are formed by pressure treatment performed on the foam layer that has foamed.

According to (2) above, it is possible to easily form the volume reduction treatment portion by simply performing the pressure treatment on the foam layer that has been foamed by being heated.

(3) According to a third aspect, in the rotating electrical machine described in (1) or (2) above, the foam layer is disposed on a surface of the insulating paper opposite to a surface that contacts the coils.

According to (3) above, the refrigerant scattered from the rotor comes into direct contact with the foam layer of the end of the insulating paper, but since the strength of the foam layer of the end is improved by the volume reduction treatment portion, the foam layer can be effectively prevented from being damaged.

(4) According to a fourth second aspect, in the rotating electrical machine described in any one of (1) to (3) above, the insulating paper covers an inner side surface (e.g., a side surface 5a of the coil 5 to be described below) in a radial direction of the coil ends in the slot.

According to (4) above, the refrigerant scattered from the rotor strongly collides with the end of the insulating paper that covers the inner side surface in the radial direction of the coil end, but since the strength of the foam layer of the end is improved by the volume reduction treatment portion, the foam layer can be effectively prevented from being damaged.

(5) A fifth aspect of the present disclosure relates to a method of manufacturing a rotating electrical machine (e.g., a rotating electrical machine 1 to be described below) including: a stator (e.g., a stator 2 to be described below) in which coils (e.g., coils 5 to be described below) are accommodated in a plurality of slots (e.g., slots 23 to be described below) arranged around an axial hole (e.g., an axial hole 22 to be described below) with insulating paper (e.g., insulating paper 4 to be described below) interposed therebetween, respectively; and a rotor (e.g., a rotor 3 to be described below) that is rotatably accommodated in the axial hole of the stator and includes therein a flow path (e.g., a refrigerant flow path 314 to be described below) of a refrigerant, the stator having coil ends (e.g., coil ends 50 to be described below) that are formed by the coils protruding from the slots in an axial direction of the stator, the rotor having an outflow port (e.g., an outflow port 314a to be described below) for the refrigerant, the refrigerant that has flowed out from the outflow port being scattered toward the coil ends of the stator by rotation of the rotor, the insulating paper including a foam layer (e.g., a foam layer 42 to be described below) that has foamed by being heated, the method including: a volume reduction treatment portion forming process including forming, at ends (e.g., protrusion ends 4d to be described below) of the insulating paper, volume reduction treatment portions (e.g., volume reduction treatment portions Fb to be described below) in which the foam layer is reduced in volume due to breakage of foamed bubbles, before inserting the insulating paper into the slots; an insertion process including inserting the insulating paper, which has the volume reduction treatment portions, into the slots together with the coils such that the ends protrude in an axial direction from the slot; and a main foaming process including making the foam layer heat-foam by heating the insulating paper in the slots and filling a clearance between the slot and the coil with the foam layer that has foamed, other than the volume reduction treatment portions.

According to (5) above, it is possible to prevent the foaming in the slot during heating and improve the strength of the foam layer at the end by simply forming the volume reduction treatment portion in the foam layer corresponding to the end of the insulating paper protruding from the slot. Therefore, it is possible to easily prevent the contamination caused by damage to the foam layer at the end of the insulating paper due to collision with the refrigerant scattered from the rotor. Since there is no need to change the design of the stator and the rotor or to introduce new equipment, the method does not increase the costs, can economically cope with the problem of damage to the foam layer at the end of the insulating paper due to the refrigerant scattered from the rotor at low cost.

(6) According to a sixth aspect, in the method of manufacturing a rotating electrical machine described in (5) above, the volume reduction treatment portion forming process includes forming the volume reduction treatment portions at the ends of the insulating paper by performing pressure treatment on the foam layer that has foamed by being locally heated.

According to (6) above, it is possible to easily form the volume reduction treatment portion by simply performing the pressure treatment on the foam layer that has foamed by being heated.

(7) According to a seventh aspect, in the method of manufacturing a rotating electrical machine described in (5) or (6) above, the insertion process includes inserting the insulating paper into the slots such that the foam layer is disposed on a surface of the insulating paper opposite to a surface that contacts the coils.

According to (7) above, the refrigerant scattered from the rotor comes into direct contact with the foam layer of the end of the insulating paper, but since the strength of the foam layer of the end is improved by the volume reduction treatment portion, the foam layer can be effectively prevented from being damaged.

(8) According to an eighth aspect, in the method of manufacturing a rotating electrical machine described in any one of (5) to (7) above, the insertion process includes inserting the insulating paper into the slot in a state where the insulating paper covers an inner side surface in a radial direction of the coil end.

According to (8) above, the refrigerant scattered from the rotor faces the end of the insulating paper that covers the inner side surface in the radial direction of the coil end, whereby the refrigerant directly collides with the end, but since the strength of the foam layer of the end is improved by the volume reduction treatment portion, the foam layer can be effectively prevented from being damaged.

According to the present disclosure, it is possible to provide a rotating electrical machine and a method of manufacturing a rotating electrical machine that can easily prevent damage to the foam layer at the end of the insulating paper due to the refrigerant scattered from the rotor.

### BRIEF DESCRIPTION OF THE DRAWINGS

FIG. 1 is an exploded perspective view illustrating a part of a rotating electrical machine according to the present embodiment;

FIG. 2 is a cross-sectional view illustrating a rotor of the rotating electrical machine according to the present embodiment;

FIG. 3 is a perspective view illustrating a coil end of a stator in the rotating electrical machine according to the present embodiment;

FIG. 4 is a plan view schematically illustrating one slot of the stator in the rotating electrical machine according to the present embodiment;

FIG. 5 is a development view of insulating paper used in the rotating electrical machine according to the present embodiment;

FIG. 6 is a cross-sectional view schematically illustrating a state of the insulating paper in a slot before foaming;

FIG. 7 is a cross-sectional view schematically illustrating a state of the insulating paper in a slot after foaming;

FIG. 8 is a diagram illustrating a manufacturing process of the insulating paper used in the rotating electrical machine according to the present embodiment; and

FIG. 9 is a vertical cross-sectional view schematically illustrating a part of the rotating electrical machine according to the present embodiment.

### DETAILED DESCRIPTION OF THE INVENTION

Hereinafter, a rotating electrical machine of the present disclosure will be described with reference to the drawings. In the following drawings, corresponding components are denoted by the same reference numerals. In addition, regarding the drawings accompanying indications of directions, an indication AD indicates an axial direction of the rotating electrical machine 1, an indication CD indicates a circumferential direction of the rotating electrical machine 1, and an indication RD indicates a radial direction of the rotating electrical machine 1. The direction indications AD, CD, and RD are also applied to a stator 2 and a rotor 3, which will be described below, in the rotating electrical machine 1.

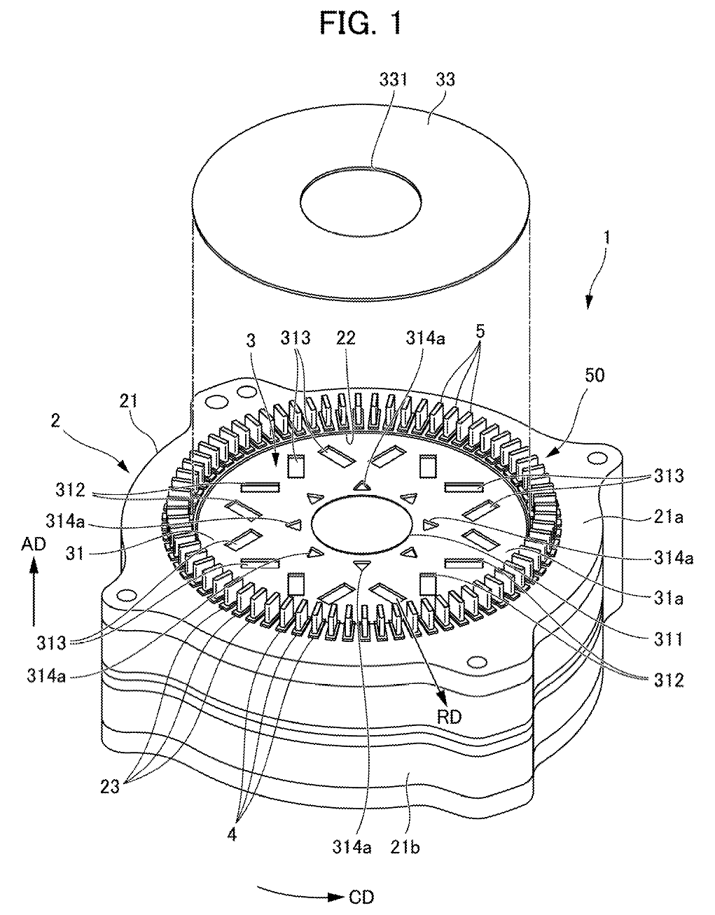

As illustrated in FIG. 1, the rotating electrical machine 1 includes a stator 2 and a rotor 3. The rotating electrical machine 1 includes a casing that forms an outer shell, but the casing is not illustrated in the rotating electrical machine 1 according to the present embodiment.

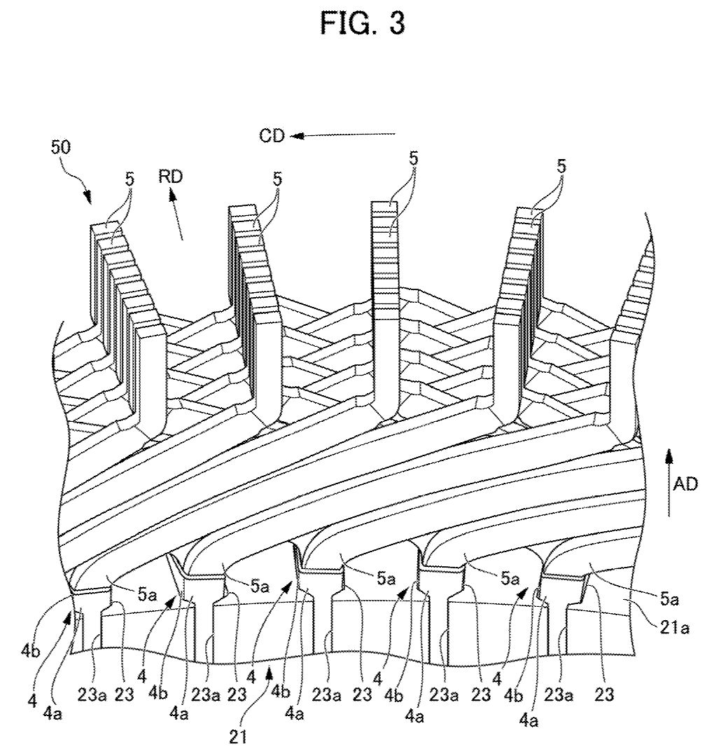

The stator 2 includes a stator core 21. The stator core 21 is formed in such a manner that a plurality of annular electrical steel plates are stacked in the axial direction. The stator core 21 includes an axial hole 22 that penetrates a center in the axial direction and a plurality of slots 23 that are arranged at equal gaps to surround a periphery of the axial hole 22. The slots 23 penetrate the stator core 21 in the axial direction and are open to both end surfaces 21a and 21a in the axial direction of the stator core 21. As illustrated in FIG. 3, each of the slots 23 has a slit 23a that extends in the axial direction of the stator core 21 and is open toward the axial hole 22.

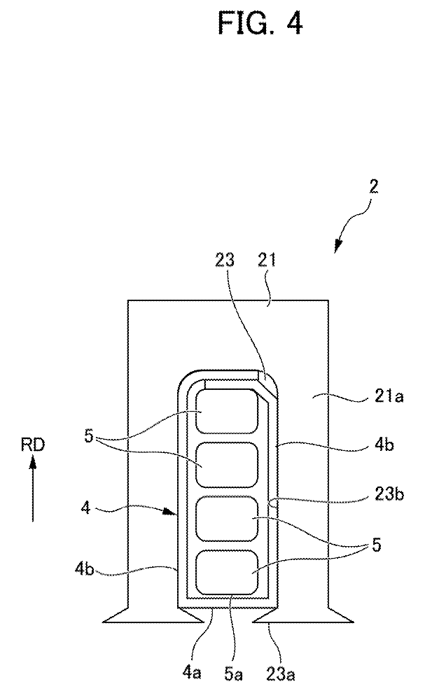

A coil 5 is inserted into each of the slots 23 through insulating paper 4. In the stator 2 of the rotating electrical machine 1 illustrated in FIG. 1, the coils 5 are schematically illustrated for ease of understanding which are inserted into each of the slots 23 and are independent for each of the slots 23. However, in general, a plurality of coils 5 made of rectangular conductors are inserted into each of the slots 23 and arranged in the radial direction, as illustrated in FIGS. 3 and 4. Ends of each of the coils 5 inserted into the slot 23 protrude from the slot 23 to both end surfaces 21a and 21a in the axial direction of the stator core 21 to form coil ends 50. The coil ends 50 are disposed on the both end surfaces 21a and 21a in the axial direction of the stator core 21, respectively.

The rotor 3 includes a rotor core 31, a rotating shaft 32, and a pair of end surface disks 33 and 33. In the rotor 3 of the rotating electrical machine 1 illustrated in FIG. 1, the rotating shaft 32 is not illustrated.

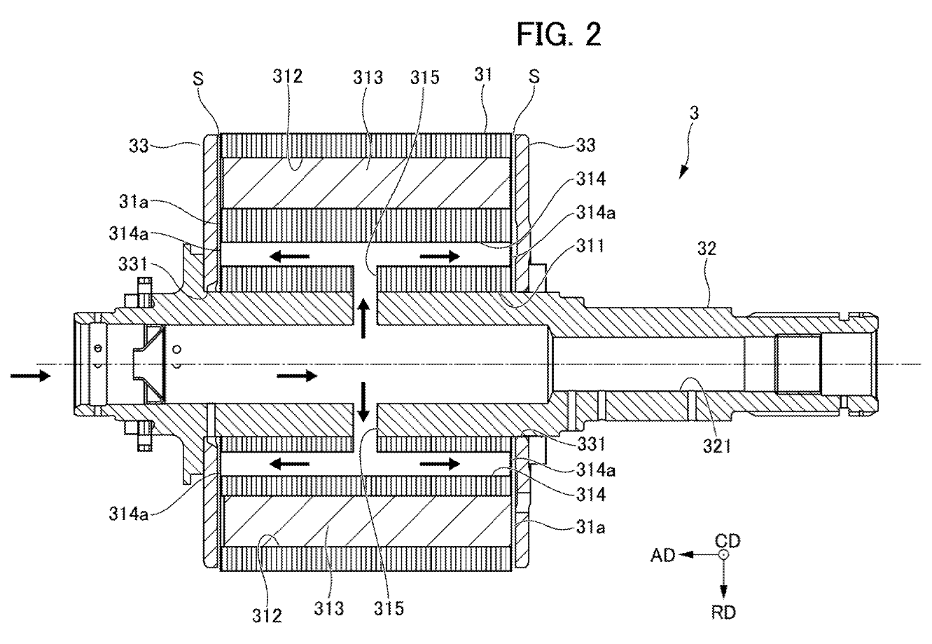

The rotor core 31 is formed in a cylindrical shape in such a manner that a plurality of electrical steel plates formed annularly are stacked in the axial direction. A length in the axial direction of the rotor core 31 is approximately equal to a length in the axial direction of the axial hole 22 of the stator core 21. The rotor core 31 includes an axial hole 311, which penetrates in the axial direction, in a central part thereof. As illustrated in FIGS. 1 and 2, the rotor core 31 has a plurality of magnet insertion holes 312, which penetrate the rotor core 31 in the axial direction, at equal gaps in the circumferential direction. A permanent magnet 313 is inserted into each of the magnet insertion holes 312.

As illustrated in FIG. 2, a plurality of refrigerant flow paths 314 are formed inside the rotor core 31 and extend in the axial direction of the rotor core 31. The plurality of refrigerant flow paths 314 are disposed inward in the radial direction from the magnet insertion hole 312 and outward in the radial direction from the axial hole 311, and are arranged at equal gaps in the circumferential direction in the rotor core 31. Both ends of each of the refrigerant flow paths 314 are open to both end surfaces 31a and 31a in the axial direction of the rotor core 31. Thus, outflow ports 314a and 314a for a refrigerant are formed on both end surfaces 31a and 31a of the rotor core 31, respectively.

The rotating shaft 32 is inserted into the axial hole 311 of the rotor core 31 and is fixed to the rotor core 31 so as not to be rotatable. A through hole 321 is formed in a center of the rotating shaft 32 to penetrate in the axial direction, as illustrated in FIG. 2. The through hole 321 forms a refrigerant flow path in the rotating shaft 32. The through hole 321 communicates with the refrigerant flow path 314 of the rotor core 31 through a communication hole 315. A refrigerant for cooling the rotor 3 flows in from one end in the axial direction of the rotating shaft 32, flows inside the through hole 321, and flows into the refrigerant flow path 314 of the rotor core 31 by passing through the communication hole 315, as indicated by an arrow in FIG. 2. The refrigerant, which has flowed into the refrigerant flow path 314, flows through the rotor core 31 in the axial direction to cool the rotor core 31, and flows out from the outflow ports 314a and 314a to the end surfaces 31a and 31a of the rotor core 31.

The pair of end surface disks 33 and 33 includes central holes 331 and 331, respectively, into which the rotating shaft 32 is inserted through a center therebetween. The end surface disks 33 and 33 cover the end surfaces 31a and 31a of the rotor core 31, respectively, with small clearances S and S through which the refrigerant can flow, the clearances being formed between the end surface disks 33 and 33 and the end surfaces 31a and 31a of the rotor core 31, respectively.

The rotor 3 is inserted into the axial hole 22 of the stator core 21, and is disposed coaxially with the stator core 21 with a predetermined gap therebetween. Both ends of the rotating shaft 32 of the rotor 3 are rotatably supported by a casing (not illustrated) via bearings. The clearances S and S between the end surface disks 33 and 33 and the end surfaces 31a and 31a of the rotor core 31 are open at a base portion of the coil ends 50 and 50 of the stator core 21 on the periphery of the rotor 3, that is, near a boundary between openings of the slots 23 and the coil ends 50 and 50. The refrigerant, which flows through the refrigerant flow path 314 of the rotor core 31 and flows out from the outflow ports 314a and 314a, flows outward in the radial direction through the clearances S and S between the end surfaces 31a and 31a of the rotor core 31 and the end surface disks 33 and 33 due to a centrifugal force generated by the rotation of the rotor 3, and is scattered toward the base portion of the coil ends 50 and 50 of the stator 2. Thus, the coil ends 50 and 50 are also cooled by the refrigerant.

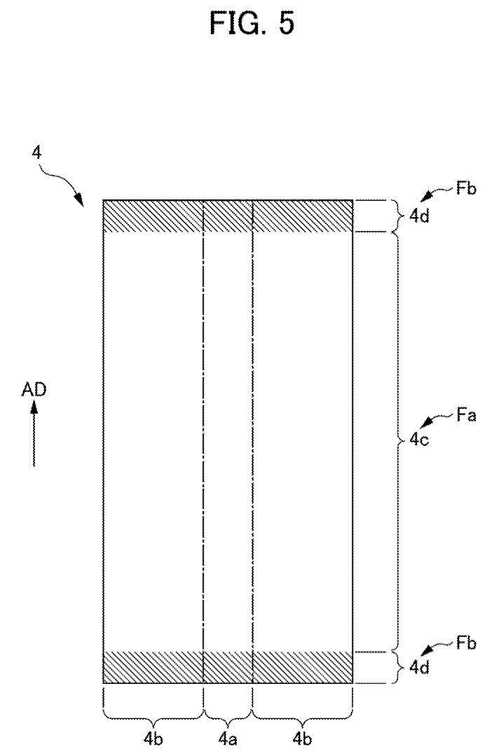

As illustrated in FIG. 4, the insulating paper 4 is disposed between an inner wall surface 23b of the slot 23 and the coils 5, and is inserted into the slot 23 so as to wrap all of the plurality of coils 5 in the slot 23 along the inner wall surface 23b. When viewed in a width direction (in a left-right direction in FIG. 5) as illustrated in FIG. 5, the insulating paper 4 includes a back portion 4a disposed in a central part and a pair of side portions 4b and 4b disposed on both left and right sides of the back portion 4a with the same width.

As illustrated in FIG. 4, the back portion 4a is disposed so as to face inward in the radial direction and close the slit 23a from the inside of the slot 23 in a state of being inserted into the slot 23. Thus, the back portion 4a covers the inner side surface in the radial direction of the coil end 50, that is, the inner side surface 5a in the radial direction of the coil 5 disposed at the innermost side in the radial direction in the slot 23. As illustrated in FIG. 4, the side portions 4b and 4b are bent outward in the radial direction along a boundary with the back portion 4a in a state of being inserted into the slot 23, and extend in the radial direction along the inner wall surface 23b of the slot 23. Outer ends in the radial direction of the side portions 4b and 4b are bent in a direction approaching each other as illustrated in FIG. 4. Thus, the insulating paper 4 is disposed so as to wrap all of the coils 5 within the slots 23.

Furthermore, when viewed in the axial direction (in an up-down direction in FIG. 5) of the stator 2 as illustrated in FIG. 5, the insulating paper 4 includes a slot accommodation portion 4c accommodated in the slot 23 and protrusion ends 4d and 4d disposed at both upper and lower ends of the slot accommodation portion 4c. The slot accommodation portion 4c and the protrusion ends 4d are formed over the back portion 4a and the pair of side portions 4b and 4b on both sides thereof. In FIG. 5, regions corresponding to the upper and lower protrusion ends 4d and 4d are indicated by hatching. When the insulating paper 4 is disposed in the slot 23 together with the plurality of coils 5, the protrusion ends 4d and 4d are portions that protrude from the slot 23 in the extending direction of the coils 5. FIG. 3 illustrates the protrusion ends 4d of the insulating paper 4 protruding from the slots 23 that are open in one end surface 21a of the stator core 21.

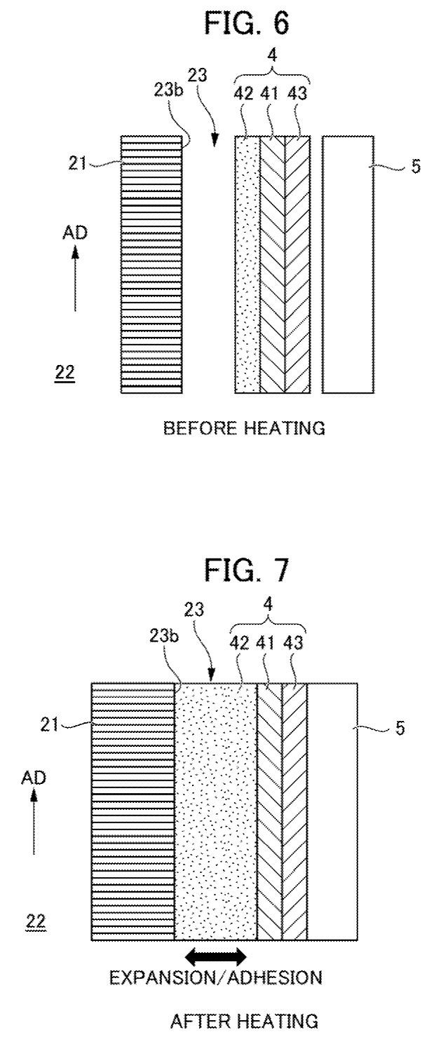

As illustrated in FIGS. 6 and 7, the insulating paper 4 includes a foam layer 42 over the entire surface on one surface side of a sheet-like substrate 41 made of paper or resin, and includes an adhesive layer 43 over the entire surface on the other surface side of the substrate 41. The foam layer 42 is formed in such a manner that foam beads (resin particles) containing a foaming agent having a heat-foaming function are dispersed in a base material made of epoxy resin, for example. Generally, the insulating paper 4 is disposed in the slot 23 together with the plurality of coils 5 as illustrated in FIG. 6. When the stator core 21 is heated in a state where the insulating paper 4 is disposed in the slot 23, the foam layer 42 exhibits its heat-foaming function and foams as illustrated in FIG. 7. Thus, the foam layer 42 expands to fill a clearance between the coils 5 and the inner wall surface 23b of the slot 23. When the adhesive layer 43 is disposed in the slot 23 to face the coils 5, the adhesive layer 43 adheres the plurality of coils 5 by heating, and when the adhesive layer 43 is disposed in the slot 23 to face the inner wall surface 23b of the slot 23, the adhesive layer 43 adheres to the inner wall surface 23b by heating. For this reason, in either case, the insulating paper 4 can fix the plurality of coils 5 in the slot 23 and hold the coils in the stator core 21.

In FIGS. 6 and 7, the insulating paper 4 is inserted into the slot 23 together with the plurality of coils 5 in the state where the foam layer 42 is disposed to face the inner wall surface 23b of the slot 23 and the adhesive layer 43 is disposed to face the coil 5. In this case, since the foam layer 42 forms an outer surface of the insulating paper 4, the protrusion ends 4d of the insulating paper 4 illustrated in FIG. 3 is in a state where the foam layer 42 is exposed toward an outer surface.

Here, the slot accommodation portion 4c is in a state of being not foamed before the insulating paper 4 disposed in the slot 23 is heated, and forms a foaming function portion Fa that exhibits a heat-foaming function as usual when heated (see FIG. 5). On the other hand, the protrusion ends 4d and 4d are prevented from being heated and foamed by volume reduction treatment of the foam layer 42, which is foamed in advance before being inserted in the slot 23, before the insulating paper 4 disposed in the slot 23 is heated, and forms a volume reduction treatment portion Fb that does not exhibit a heat-foaming function or is less likely to exhibit the heat-foaming function than the foaming function portion Fa when the insulating paper 4 is heated again in the slot 23.

The volume reduction treatment portion Fb can be formed in such a manner that a physical force acts on an area foamed by heating from the outside to break foamed bubbles by collapsing, crushing, or the like, thereby reducing the volume. In the present embodiment, the volume reduction treatment portion Fb is formed in such a manner that the foam layer 42 is locally heated and foamed in advance before the insulating paper 4 is inserted into the slot 23 and then pressure treatment is performed on the foamed area to crush foamed bubbles and reduce the volume. Since the volume reduction treatment portion Fb does not foam or is difficult to foam even when being subjected to heating (main heating) in the slot 23, foamed bubbles in the foam layer 42 are collapsed and resin walls overlap with each other, whereby the volume reduction treatment portion Fb has higher mechanical strength than the foaming function portion Fa, and a thickness of the volume reduction treatment portion Fb in the insulating paper 4 after the heating (main heating) in the slot 23 is thinner than that of the foaming function portion Fa. The volume reduction treatment portion Fb may be formed over a region slightly larger than the region of the protrusion end 4d so as not to disturb a fixing function of the coils 5 due to the foaming of the foam layer 42 disposed in the slot accommodation portion 4c.

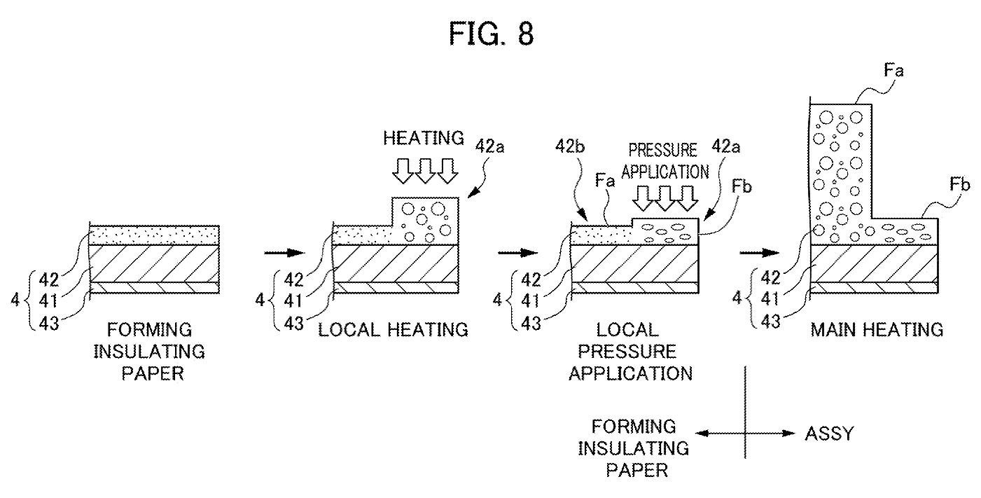

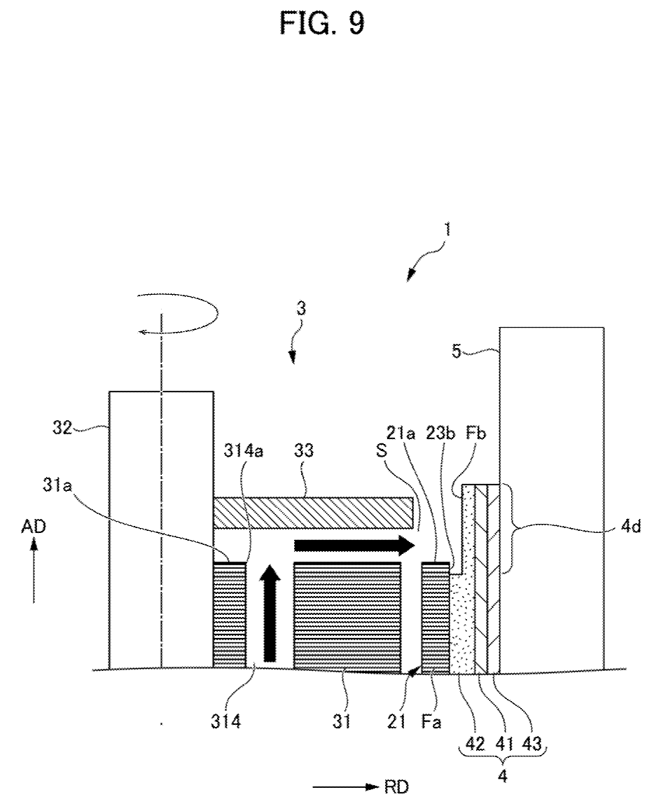

Next, a manufacturing process of the insulating paper 4, which is one process in a manufacturing method of the rotating electrical machine 1, will be described with reference to FIG. 8. FIG. 8 illustrates a process (an insulating paper forming process) before the insulating paper 4 is disposed in the slot 23 of the stator core 21, and a process (ASSY) after the insulating paper 4 is disposed in the slot 23 of the stator core 21.

First, a foam layer 42 is formed over the entire surface of one surface side of the sheet-like substrate 41 to exhibit a foaming function due to heating, and an adhesive layer 43 is formed on the other surface side, whereby an insulating paper 4 is formed (insulating paper forming process). As such an insulating paper 4, a generally commercial product may be used in which a foam layer 42 is formed on the entire surface of one surface side.

Next, the foam layer 42 corresponding to the protrusion ends 4d and 4d of the insulating paper 4 is subjected to local heating. Such local heating causes foam beads in the foam layer 42 at the heated area to exhibit a heat-foaming function, whereby a local foam portion 42a is formed in the foam layer 42 (local heating process).

There is no particular restriction on a specific method of performing locally heating. Examples of such methods include: a method of heating the insulating paper 4 while masking the region of the slot accommodation portion 4c where the foaming function portion Fa is to be formed with respect to the foam layer 42 of the insulating paper 4 with a masking member having insulating properties; a method of using a heating element capable of selectively heating and bringing the heating element into contact with the regions of the protrusion ends 4d and 4d in the foam layer 42 of the insulating paper 4 where the volume reduction treatment portions Fb are to be formed, thereby selectively heating only the contact area; and a method of selectively irradiating the regions of the protrusion ends 4d and 4d where the volume reduction treatment portions Fb are to be formed, with laser light to heat the regions. The heating temperature at this time is a temperature at which the locally heated area of the foam layer 42 exhibits a heat-foaming function and starts to foam, but the adhesive layer 43 does not yet exhibit adhesive strength.

Next, the foam portion 42a formed by foaming of the foam beads in the local heating process is forcibly crushed by applying pressure (local pressure treatment). When the foam portion 42a is forcibly crushed, bubbles formed by foaming are crushed, and the volume of the foam portion 42a is reduced. Accordingly, strength of resin walls between the foam beads, which become thinner due to the foaming, increases as the resin walls overlap each other.

Due to the local pressure treatment, volume reduction treatment portions Fb are formed in the foam layer 42 at the protrusion ends 4d and 4d, and a foaming function portion Fa is formed in the foam layer 42 by an unfoamed portion 42b other than the volume reduction treatment portions Fb. In the volume reduction treatment portion Fb, since the foam beads in the foam layer 42 have already been foamed, the foam beads lose the foaming function, and are not foamed or are hardly foamed even when heated again. On the other hand, in the foaming function portion Fa, the foam beads are in a state of not being foamed, and therefore exhibit a foaming function to foam when heated.

Next, the insulating paper 4, in which the volume reduction treatment portion Fb is formed and the foaming function portion Fa is in an unfoamed state, is inserted into the slots 23 of the stator core 21 together with the plurality of coils 5 (insertion process). The entire slot accommodation portion 4c of the insulating paper 4 is disposed in the slot 23. The protrusion ends 4d and 4d of the insulating paper 4 protrude from both ends in the axial direction of the slot 23. As illustrated in FIG. 9, the insulating paper 4 is disposed in the slot 23 such that the surface on which the foam layer 42 is formed faces the inner wall surface 23b of the slot 23 and the surface on which the adhesive layer 43 is formed faces the coil 5.

Thereafter, the stator core 21 is heated to heat the entire insulating paper 4, thereby causing the foam layer 42 of the foaming function portion Fa to foam (main heating process). The heating temperature at this time is a temperature at which the foam layer 42 exhibits a heat-foaming function and starts to foam as usual, and the adhesive layer 43 exhibits adhesive strength. The foaming function portion Fa, which is a portion of the foam layer 42 other than the volume reduction treatment portion Fb, is not heated in the local heating process, and therefore exhibits the heat-foaming function to foam as usual when heated in the main heating process. Thus, the foaming function portion Fa to be foamed of the slot accommodation portion 4c fills the clearance between the coil 5 and the inner wall surface 23b of the slot 23, and the adhesive layer 43 exhibits an adhesive function in the slot 23, and fixes the plurality of coils 5 in the slot 23. On the other hand, the volume reduction treatment portion Fb is not foamed at all or is hardly foamed in the main foaming process, and thus, as illustrated in FIG. 9, is formed to be relatively thinner than the foaming function portion Fa that is expanded by foaming.

After the stator 2 is formed, the rotor 3 is inserted into the axial hole 22 of the stator 2. The rotating shaft 32 of the rotor 3 is rotatably supported by a bearing of a casing (not illustrated). In the rotating electrical machine 1 obtained in this way, the protrusion end 4d of the insulating paper 4 is disposed on the outer side in the radial direction of the end surface disk 33 of the rotor 3 as illustrated in FIG. 9. The volume reduction treatment portion Fb of the insulating paper 4 is disposed so as to face the clearance S between the end surface 31a in the axial direction of the rotor core 31 and the end surface disk 33 from the outer side in the radial direction. In the present embodiment, the volume reduction treatment portion Fb is formed over a region that is wider in the axial direction than the region of the protrusion end 4d protruding from the end surface 21a of the stator core 21. Therefore, the volume reduction treatment portion Fb extends to a position slightly deeper into the slot 23 than the end surface 21a of the stator core 21, as illustrated in FIG. 9.

In such a rotating electrical machine 1, as indicated by arrows in FIG. 9, a refrigerant flowing out from an outflow port 314a of a refrigerant flow path 314 of the rotor 3 is scattered toward the coil end 50 outside in the radial direction due to the rotation of the rotor 3, and collides with the protrusion end 4d of the insulating paper 4 through the clearance S at high speed. However, since the volume reduction treatment portion Fb with locally increased strength is formed in the foam layer 42 corresponding to the protrusion end 4d, the foam layer 42 is less likely to be scraped off, and occurrence of contamination is restrained or prevented. The present inventor has confirmed that for example, even when a fluid (water) with a scattering pressure 50 MPa collides with the volume reduction treatment portion Fb of the insulating paper 4 in the rotating electrical machine 1 manufactured in this way, the foam layer 42 is not scrapped off and no peeling is observed. Since the scattering pressure (50 MPa) is much greater than 2 to 6 MPa which are normal scattering pressures of the refrigerant caused by the rotation of the rotor 3, it can be seen that the occurrence of contamination from the insulating paper 4 is effectively restrained or prevented when the rotating electrical machine 1 is operating.

The rotating electrical machine 1 according to the present embodiment provides the following effects. The rotating electrical machine 1 includes: a stator 2 in which coils 5 are accommodated in a plurality of slots 23 arranged around an axial hole 22 with insulating paper 4 interposed therebetween, respectively; and a rotor 3 that is rotatably accommodated in the axial hole 22 of the stator 2 and includes therein a refrigerant flow path 314. The stator 2 has coil ends 50 that are formed by the coils 5 protruding from the slots 23 in an axial direction of the stator 2. The rotor 3 has an outflow port 314a for the refrigerant, and the refrigerant that has flowed out from the outflow port 314a is scattered toward the coil ends 50 of the stator 2 by rotation of the rotor 3. The insulating paper 4 includes a foam layer 42 that has foamed by being heated in the slots 23 and fills a clearance between the slots 23 and the coils 5, is accommodated in the slots 23 such that ends (protrusion ends 4d) of the insulating paper 4 protrude from the slots 23 in the axial direction of the stator 2. The protrusion ends 4d of the insulating paper 4 are provided with volume reduction treatment portions Fb in which the foam layer 42 is reduced in volume due to breakage of foamed bubbles. Thus, it is possible to improve the strength of the foam layer 42 at the protrusion end 4d by simply forming the volume reduction treatment portion Fb in the foam layer 42 corresponding to the protrusion end 4d of the insulating paper 4. Therefore, it is possible to easily prevent the contamination caused by damage to the foam layer 42 at the protrusion end 4d of the insulating paper 4 due to collision with the refrigerant scattered from the rotor 3. Since there is no need to change the design of the stator 2 and the rotor 3 or to introduce new equipment, there is no increase in costs, and it is possible to economically cope with the problem of damage to the foam layer 42 of the insulating paper 4 due to the refrigerant scattered from the rotor 3 at low cost.

In the present embodiment, the volume reduction treatment portions Fb are formed by pressure treatment performed on the foam layer 42 foamed. Thus, it is possible to easily form the volume reduction treatment portion Fb by simply performing pressure treatment on the foam layer 42 that has been foamed by being heated.

In the present embodiment, the foam layer 42 is disposed on a surface of the insulating paper 4 opposite to a surface that contacts the coils 5. Thus, the refrigerant scattered from the rotor 3 comes into direct contact with the foam layer 42 of the protrusion end 4d of the insulating paper 4. However, since the strength of the foam layer 42 of the protrusion end 4d is improved by the volume reduction treatment portion Fb, the foam layer 42 can be effectively prevented from being damaged.

In the present embodiment, the insulating paper 4 covers an inner side surface (side surface 5a of the coil 5) in a radial direction of the coil ends 50 in the slot 23. Thus, the refrigerant scattered from the rotor 3 strongly collides with the protrusion end 4d of the insulating paper 4 that covers the inner side surface in the radial direction of the coil end 50 (the side surface 5a of the coil 5). However, since the strength of the foam layer 42 of the protrusion end 4d is improved by the volume reduction treatment portion Fb, the foam layer 42 can be effectively prevented from being damaged.

The method of manufacturing the rotating electrical machine 1 according to the present embodiment provides the following effects. The method of manufacturing the rotating electrical machine 1 including: a stator 2 in which coils 5 are accommodated in a plurality of slots 23 arranged around an axial hole 22 with insulating paper 4 interposed therebetween, respectively; and a rotor 3 that is rotatably accommodated in the axial hole 22 of the stator 2 and includes therein a refrigerant flow path 314, the stator 2 having coil ends 50 that are formed by the coils 5 protruding from the slots 23 in an axial direction of the stator 2, the rotor 3 having an outflow port 314a for the refrigerant, the refrigerant that has flowed out from the outflow port 314a being scattered toward the coil ends 50 of the stator 2 by rotation of the rotor 3, the insulating paper 4 including a foam layer 42 that has foamed by being heated, the method including: a volume reduction treatment portion forming process including forming, at ends of the insulating paper 4, volume reduction treatment portions Fb in which the foam layer 42 is reduced in volume due to breakage of foamed bubbles, before inserting the insulating paper 4 into the slots 23; an insertion process including inserting the insulating paper 4, which has the volume reduction treatment portions Fb, into the slots 23 together with the coils 5 such that the ends (protrusion ends 4d) protrude in an axial direction from the slot 23; and a main foaming process including making the foam layer 42 heat-foam by heating the insulating paper 4 in the slots 23 and filling a clearance between the slot 23 and the coil 5 with the foam layer 42 that has foamed, other than the volume reduction treatment portions Fb. Thus, it is possible to improve the strength of the foam layer 42 at the protrusion end 4d by simply forming the volume reduction treatment portion Fb in the foam layer 42 corresponding to the protrusion end 4d of the insulating paper 4 protruding from the slot 23. Therefore, it is possible to easily prevent the contamination caused by damage to the foam layer 42 at the protrusion end 4d of the insulating paper 4 due to collision with the refrigerant scattered from the rotor 3. Since there is no need to change the design of the stator 2 and the rotor 3 or to introduce new equipment, there is no increase in costs, and it is possible to economically cope with the problem of damage to the foam layer 42 of the insulating paper 4 due to the refrigerant scattered from the rotor 3 at low cost.

In the present embodiment, the volume reduction treatment portion forming process includes forming the volume reduction treatment portions Fb at the protrusion ends 4d of the insulating paper 4 by performing pressure treatment on the foam layer 42, which has been foamed by being locally heated. Thus, it is possible to easily form the volume reduction treatment portion Fb by simply performing pressure treatment on the foam layer 42 that has foamed by being heated.

In the present embodiment, the insertion process includes inserting the insulating paper 4 into the slot such that the foam layer 42 is disposed on a surface of the insulating paper 4 opposite to a surface that contacts the coils 5. Thus, the refrigerant scattered from the rotor 3 comes into direct contact with the foam layer 42 of the protrusion end 4d of the insulating paper 4. However, since the strength of the foam layer 42 of the protrusion end 4d is improved by the volume reduction treatment portion Fb, the foam layer 42 can be effectively prevented from being damaged.

In the present embodiment, the insertion process includes inserting the insulating paper 4 into the slot 23 in a state where the insulating paper covers an inner side surface (side surface 5a of the coil 5) in a radial direction of the coil end 50. Thus, the refrigerant scattered from the rotor 3 strongly collides with the protrusion end 4d of the insulating paper 4 that covers the inner side surface in the radial direction of the coil end 50 (the side surface 5a of the coil 5). However, since the strength of the foam layer 42 of the protrusion end 4d is improved by the volume reduction treatment portion Fb, the foam layer 42 can be effectively prevented from being damaged.

In the above embodiment, the protrusion ends 4d and 4d of the insulating paper 4 in the slot 23 are disposed to protrude from both end surfaces 21a and 21a in the axial direction of the stator core 21, respectively, but the protrusion end 4d of the insulating paper 4 in the slot 23 may only protrude from either of the end surfaces 21a in the axial direction of the stator core 21. In this case, the volume reduction treatment portion Fb is formed only in the foam layer 42 of the protrusion end 4d protruding from the slot 23.

In the above embodiment, the refrigerant flowing out from the outflow port 314a of the refrigerant flow path 314 formed on the end surface 31a in the axial direction of the rotor 3 is configured to be scattered toward the coil end 50 through the clearance between the end surface 31a and the end surface disk 33, but the present invention is not limited to such a rotor as long as the refrigerant scattered by the rotation of the rotor is scattered toward the coil end 50. For example, the rotor may not be provided with the end surface disk. Instead of the end surface disk, a lid including a through hole on only the end surface may be provided, and the refrigerant scattered by the rotation of the rotor may be scattered toward the coil end 50 from the through hole.

### EXPLANATION OF REFERENCE NUMERALS

1 rotating electrical machine
2 stator
22 axial hole
23 slot
3 rotor
314 refrigerant flow path
314a outflow port
4 insulating paper
4d protrusion end (end of insulating paper)
42 foam layer
5 coil
5a side surface (inner side surface in radial direction of coil end)
50 coil end Fb volume reduction treatment portion

What is claimed is:

1. A rotating electrical machine comprising:
a stator in which coils are accommodated in a plurality of slots arranged around an axial hole with insulating paper interposed therebetween, respectively; and
a rotor that is rotatably accommodated in the axial hole of the stator and includes therein a flow path for a refrigerant,
the stator having coil ends that are formed by the coils protruding from the slots in an axial direction of the stator,
the rotor having an outflow port for the refrigerant, wherein the refrigerant that has flowed out from the outflow port is scattered toward the coil ends of the stator by rotation of the rotor,
the insulating paper including a foam layer that has foamed by being heated in the slots and fills a clearance between the slots and the coils, and being accommodated in the slots such that ends of the insulating paper protrude from the slots in the axial direction of the stator,
the ends of the insulating paper being provided with volume reduction treatment portions having higher mechanical strength than foamed portions in the slots, in which the foam layer is reduced in volume due to breakage of foamed bubbles.

2. The rotating electrical machine according to claim 1, wherein the volume reduction treatment portions are formed by pressure treatment performed on the foam layer that has foamed.

3. The rotating electrical machine according to claim 1, wherein the foam layer is disposed on a surface of the insulating paper opposite to a surface that contacts the coils.

4. The rotating electrical machine according to claim 1, wherein the insulating paper covers an inner side surface in a radial direction of the coil ends in the slot.

5. A method of manufacturing a rotating electrical machine,
the rotating electrical machine including:
a stator in which coils are accommodated in a plurality of slots arranged around an axial hole with insulating paper interposed therebetween, respectively; and
a rotor that is rotatably accommodated in the axial hole of the stator and includes therein a flow path for a refrigerant,
the stator having coil ends that are formed by the coils protruding from the slots in an axial direction of the stator,
the rotor having an outflow port for the refrigerant, wherein the refrigerant that has flowed out from the outflow port is scattered toward the coil ends of the stator by rotation of the rotor,
the insulating paper including a foam layer that has foamed by being heated,
the method comprising:
a volume reduction treatment portion forming process including forming, at ends of the insulating paper, volume reduction treatment portions in which the foam layer is reduced in volume due to breakage of foamed bubbles, before inserting the insulating paper into the slots;
an insertion process including inserting the insulating paper, which has the volume reduction treatment portions, into the slots together with the coils such that the ends protrude in an axial direction from the slot; and
a main foaming process including making the foam layer heat-foam by heating the insulating paper in the slots and filling a clearance between the slot and the coil with the foam layer that has foamed, other than the volume reduction treatment portions.

6. The method according to claim 5, wherein the volume reduction treatment portion forming process includes forming the volume reduction treatment portions at the ends of the insulating paper by performing pressure treatment on the foam layer that has foamed by being locally heated.

7. The method according to claim 5, wherein the insertion process includes inserting the insulating paper into the slots such that the foam layer is disposed on a surface of the insulating paper opposite to a surface that contacts the coils.

8. The method according to claim 5, wherein the insertion process includes inserting the insulating paper into the slots in a state where the insulating paper covers an inner side surface in a radial direction of the coil ends.
